(19) United States
(12) Patent Application Publication
(10) Pub. No.: US 2014/0365100 A1
(43) Pub. Date: Dec. 11, 2014

(54) VEHICLE CONTROL BASED ON SENSED ENVIORNMENTAL CONDITION

(71) Applicant: Gary J. Speier, Eden Prairie, MN (US)

(72) Inventor: Gary J. Speier, Eden Prairie, MN (US)

(21) Appl. No.: 14/300,943

(22) Filed: Jun. 10, 2014

Related U.S. Application Data
(60) Provisional application No. 61/833,557, filed on Jun. 11, 2013.

(51) Int. Cl. F02D 35/00; B60W 50/00

(52) U.S. Cl. CPC F02D 35/00; B60W 50/00
USPC 701/101; 701/1; 701/99

(57) ABSTRACT

A system may include a sensor configured to detect an environmental condition within a vehicle and a controller, operatively coupled to the sensor, configured to control an operation of the vehicle based, at least in part, on the environmental condition as detected by the sensor and an operation state of the vehicle. The operation state of the vehicle may be related, at least in part, to a source of the environmental condition

### PRIORITY

This application claims priority to U.S. Provisional Application No. 61/833,557, “VEHICLE CONTROL BASED ON SENSED ENVIRONMENTAL CONDITION,” filed Jun. 11, 2013, which is incorporated by reference herein in its entirety.

### TECHNICAL FIELD

The subject matter disclosed herein generally relates to techniques for controlling a vehicle based on a sensed environmental condition, such as a condition generated at least in part by the operation of the vehicle.

### BACKGROUND

The operation of transportation vehicles may generate emissions of a variety of types. For instance, a gasoline or diesel engine is well known to intentionally generate a variety of gaseous emissions as part of the combustion process. Other components of the vehicle, such as other components of the powertrain and environmental control systems including air conditioning, heat, and the like, may unintentionally produce or substantially increase emissions during operation, such as if the system is malfunctioning. Such emissions may be gas, liquid, or both. As such emissions may be hazardous in sufficiently high concentrations, such emissions are conventionally vented from or otherwise directed outside of the vehicle. Further, a vehicle may be configured to prevent outside gasses or other contaminants from entering the vehicle during vehicle operation.

### BRIEF DESCRIPTION OF THE DRAWINGS

Some embodiments are illustrated by way of example and not limitation in the figures of the accompanying drawings.

FIG. 1 is a block system diagram of a vehicle.

FIG. 2 is a depiction of a vehicle.

FIG. 3 is a flow diagram for controlling a vehicle based on an environmental condition based, at least in part, on an output from a sensor.

FIG. 4 is a block diagram illustrating components of a machine able to read instructions from a machine-readable medium.

### DETAILED DESCRIPTION

Vehicle systems to direct undesirable emissions generated by the vehicle may malfunction or otherwise fail to prevent unsafe concentrations of such emissions from developing in a passenger space of the vehicle. Systems configured to prevent or otherwise limit the introduction of environmental contaminants into the passenger space may similarly fail or be overwhelmed by an environmental condition external to the vehicle. As a result of these or other conditions related to the operation of the vehicle, concentrations of such emissions or contaminants in the passenger space may rise to unsafe or otherwise undesirable levels.

Various vehicles, such as tractor trailers and recreational vehicles, may be occupied for extended periods of time, including times in which people sleep or otherwise conduct conventional residential activities. Such vehicles may be expected to be operational over all or most of those extended periods of time, such as by having the engine running to provide power and environmental control even when not in motion. Such circumstances may increase a risk of an environmental condition within the passenger space reaching unsafe or undesirable levels. Even vehicles which are not necessarily designed to be occupied or operated for extended periods of time, such as a conventional car, may be susceptible to the buildup of emissions or contaminants over relatively short periods of time.

A system and related components and processes have been developed that may control, at least in part, the operation of a vehicle and/or systems thereof based on a sensed environmental condition in a passenger space. For instance, if concentrations of carbon monoxide, which may be generated by the engine of the vehicle, rise above a predetermined threshold, operation of the engine or other components of the vehicle's power train may be restricted. Additionally or alternatively, systems to mitigate the impact of the environmental condition, such as a ventilation system, may be engaged. The control of the vehicle based on a sensed environmental condition may be based, at least in part, on a current operating condition of the vehicle, such as if the vehicle is in motion.

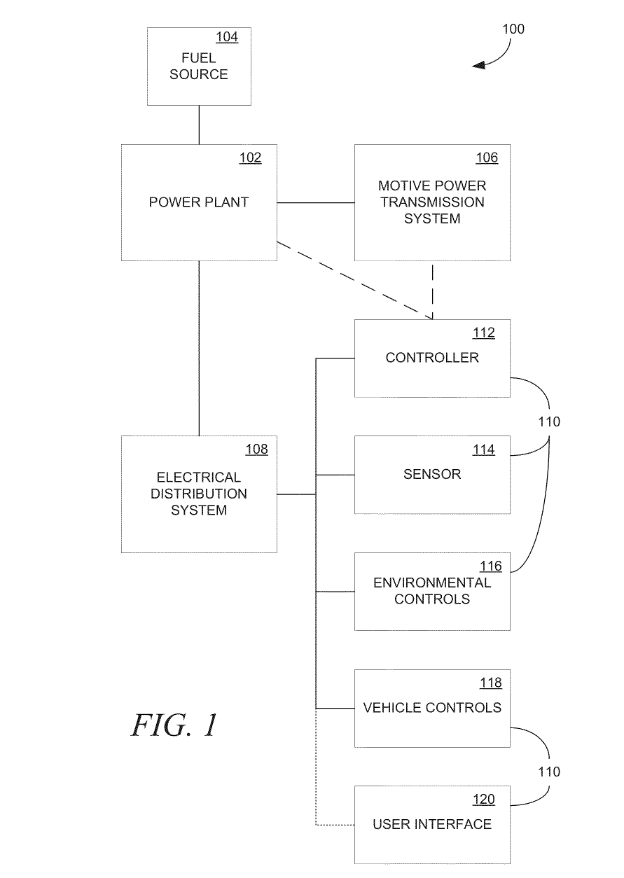

FIG. 1 is a block system diagram of a vehicle 100. While the vehicle 100 may generally be discussed herein in terms of a passenger road vehicle, it is to be understood that the vehicle 100 may be any of a variety of vehicles known in the art, including but not limited to a ship, an airplane, and so forth.

The vehicle includes a power plant 102 configured to generate power for the operation of the vehicle 100, such as motive power for propelling the vehicle and/or electrical power for running vehicle systems. The power plant 102 may be any of a variety of power plants known in the art, including but not limited to internal combustion engines, such as gasoline or diesel engines, jet engines, boilers, and so forth, and electric motors. The power plant 102 may be supplied by an appropriate fuel source 104 and may incorporate or otherwise be operatively coupled to a battery or other electrical storage source.

The vehicle 100 may include a motive power transmission system 106 as appropriate. For instance, motive power transmission system 106 may be a powertrain for a road vehicle. A jet engine-powered aircraft may not incorporate a motive power transmission system 106, or the motive power transmission system 106 may be understood to incorporate components of or coupled a jet engine or other aircraft engine power plant 102 to generate thrust to propel the aircraft.

The vehicle 100 may further include an electrical distribution system 108 configured to distribute electrical power from the power plant 102 to vehicle systems 110. Such vehicle systems may include a controller 112 configured to control, at least in part, operation of the vehicle 100 generally, including but not limited to the power plant 102 and other systems 110. The controller 112 may incorporate electrical elements, such as a processor and electronic control lines, and/or mechanical elements, such as hydraulic actuators to control vehicle 100 operation.

Other systems 110 include at least one sensor 114. The sensor 114 is configured to detect an environmental condition within the vehicle, such as within a passenger space, as disclosed herein. The sensor 114 may be any of a variety of sensors known in the art for the detection of any of a variety of environmental conditions that may develop from the operation of the vehicle 100, generally, and/or components of the vehicle, such as the power plant 102.

The sensor 114 may be configured or selected to detect emissions or other environmental conditions that may be expected to be generated by the power plant 102. For instance, if the power plant 102 is a diesel engine, the sensor 114 may be configured to detect some or all of carbon monoxide, carbon dioxide, nitrous oxide, hydrocarbons, and other known emissions from diesel engines. In addition or alternatively, the sensor may be configured or selected to detect particulate matter, including particular matter generally and/or particulate matter of particular characteristics that may be associated with the power plant 102. It is emphasized that any particular sensor 114 may be selected to detect any particular environmental condition as appropriate to the power plant 102 and/or the operation of the vehicle 100 generally.

Further, the sensor 114 may be configured or selected to detect any environmental condition within the passenger space, whether or not the environmental condition is related to the operation of the power plant 102. The environmental condition may be related or unrelated to the operation of the vehicle. For instance, the environmental condition may be related to the byproducts of a fire from the electrical distribution system 108, a blockage in an exhaust system, and so forth. In further examples, the environmental condition may be related to environmental conditions that may be introduced to the vehicle 100 from outside sources, such as ambient gases or particular matter. Such environmental conditions introduced from external sources may, for instance, be mitigated within the vehicle 100 by the operation of vehicle systems such as environmental controls 116 like air conditioning, filters, and the like.

The sensor 114 may be any of a variety of sensor types known in the art. In various examples, the sensor 114 may be a multi-use sensor not reliant on physical replacement upon identifying a corresponding environmental condition. Such sensors 114 may include, but are not necessarily limited to, an electrochemical sensor, a semiconductor sensor, an infrared laser absorption sensor, and the like. Alternatively or additionally, the sensor 114 may be a sensor that includes an element that may be replaced upon detection of the corresponding environmental condition, such as an opto-chemical sensor or a biomimetic sensor.

The systems 110 further include vehicle controls 118, such as, in the case of a conventional road vehicle, a steering mechanism (e.g., a conventional steering wheel), a gear box, an accelerator, a brake, a clutch, and the like. The vehicle controls 118 may be coupled to some or all of the power plant 102, the motive power transmission system 106, and the controller 112 for the purposes of providing some control of the motive operation of the vehicle 100 to a driver of the vehicle 100. In various examples, the vehicle controls 118 may control the power plant 102 and motive power transmission system 106 directly or via the controller 112, such as in a system based on electronic control (e.g., a “fly-by-wire” system).

The systems 110 may further include a user interface 120, such as may provide messages to users of the vehicle 100 and/or receive inputs from the user. The user interface 120 may include one or more of a speaker, a display, and a user input, such as a touchscreen or a keypad. The user interface may be an independent or otherwise dedicated system 110 or may be incorporated, in whole or in part, within an entertainment system and/or environmental control system of the vehicle 100.

It is noted that the vehicle 100 may be understood as a system that does not necessarily include all of the components 102-120 within a single object. For instance, the controller 112 may be located remotely and communicated with wirelessly. Alternatively or additionally, the controller 112 may be supplemented with additional processing resources remote to the vehicle. Consequently, control of the vehicle 100 may be based, at least in part, on commands generated from a controller 112 or other processor remote to the vehicle 100.

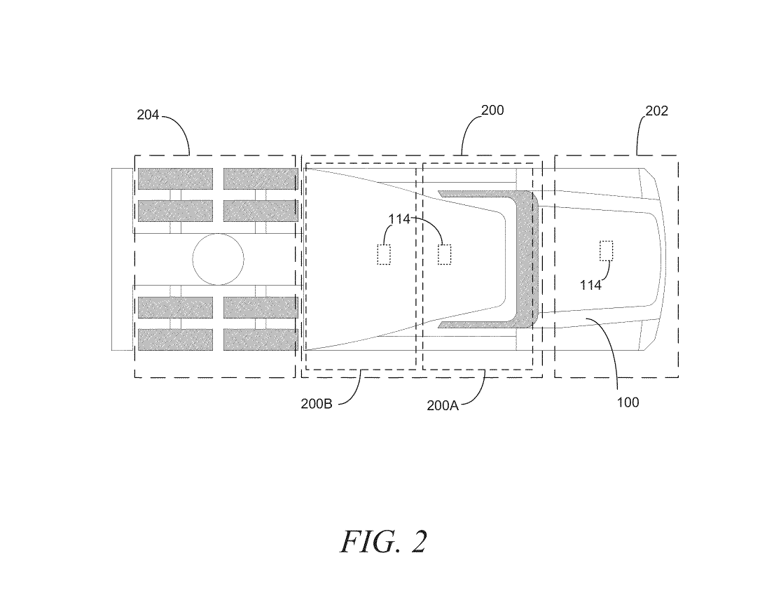

FIG. 2 is a depiction of a vehicle 100. As illustrated, the vehicle is a semi-tractor. The vehicle 100 includes a passenger space 200, a power plant compartment 202 including, at least in part, the power plant 102, and a portion of the motive power transmission system 106, including wheels and axles 204.

The passenger space 200 may be configured to admit one or more passengers in a variety of configurations. In the illustrated example, the passenger space 200 of the vehicle 100 may include one a vehicle control area 200A with passenger seating configured to provide access to the vehicle controls 118 and a living area 200B, such as with sleeping accommodations and the like. Alternative configurations are contemplated and well known in the art, including a passenger space 200 without a sleeping area.

The vehicle 100 includes the sensor 114 in one or more locations. As illustrated, the vehicle 100 includes the sensor 114 within the passenger space 200 generally and within the vehicle control area 200A in particular. In various examples, the sensor 114 is alternatively positioned within the living area 200B or a second sensor 114 is positioned within the living area 200B in addition to the first sensor 114 positioned within the control area 200A. The passenger space 200 generally may incorporate as many sensors 114 as may usefully detect particular or general environmental conditions as is desired to promote passenger safety. Additionally, the sensors 114 may be positioned within the passenger space 200 appropriate to the environmental condition the sensors 114 are configured to detect. For instance, a sensor 114 configured to detect a gas that tends to rise may be positioned proximate the ceiling of the passenger space 200 while a sensor 114 configured to detect a gas or particles that tend to sink may be positioned proximate the floor of the passenger space 200.

Additionally or alternatively, the sensor 114 may be positioned within the power plant compartment 202 or otherwise coupled to the power plant 102. Such as sensor 114 may detect an environmental condition as produced by the power plant 102 or otherwise as is present in the power plant compartment 202 prior to or concurrent with the environmental condition becoming present in the passenger space 200. As is detailed herein, the vehicle 100 in general may incorporate as many sensors 114 positioned at various locations within the vehicle 100 as may be desired.

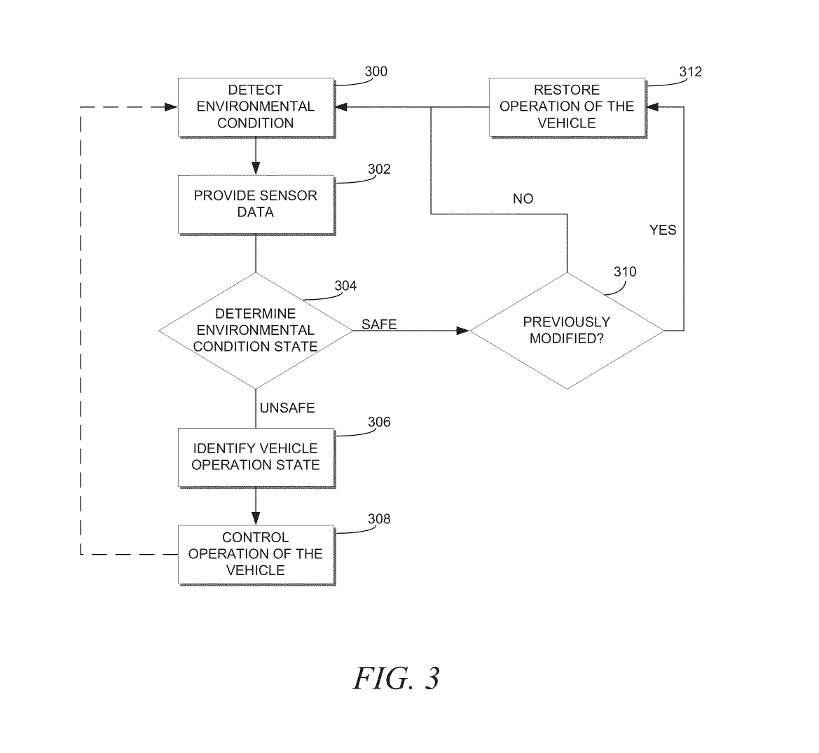

FIG. 3 is a flow diagram for controlling the vehicle 100 based on an environmental condition based, at least in part, on an output from the sensor 114. While the flow diagram will be discussed with respect to a sensor 114, it is to be noted and emphasized that references to a sensor 114 may refer to a system or collection of multiple individual sensors 114 as incorporated on or within the vehicle 100 in a single or various locations.

At 300, the sensor 114 detects an environmental condition within the vehicle 100, such as within the passenger space 200. In various examples, the sensor 114 may store detected environmental condition data for later provision in a block of sensor data or may stream the sensor data essentially continually.

At 302, the sensor 114 provides sensor data to the controller 112. The sensor data may be provided as a block of environmental condition data collected over time or as an essentially continuous data stream, such as with a frequency approximately the rate at which the sensor data is collected. The sensor data may be indicative, at least in part, of an environmental condition within the vehicle 100, such as within the passenger space 200. For instance, if the sensor 114 is or includes a carbon monoxide detector positioned in the passenger space 200, the sensor data may be indicative of a level of carbon monoxide within the passenger space 200.

In various examples, the sensor data as provided by the sensor 114 is “raw” data related to the environmental condition. In such an example, in the carbon monoxide example above, the sensor data may be detected carbon monoxide in parts-per-million. Alternatively or additionally, the sensor data is more generally indicative of the environmental condition, such as by providing a binary indication of an environmental condition that is either above or below a particular threshold, such as a threshold that is safe or unsafe, or a graduated series of levels. For instance, the sensor data may indicate that a carbon monoxide level is “safe” or “unsafe”, in the binary indication example, or that the carbon monoxide level falls into one of multiple levels, such as levels from one to five indicating progressively higher detected concentrations of carbon monoxide without necessarily transitioning from a “safe” to an “unsafe” condition. Alternative formatting for the sensor data is contemplated as appropriate to the particular sensors 114.

In various examples, a carbon monoxide detection limit of five hundred (500) parts-per-million is the threshold between a “safe” and an “unsafe” environmental condition. In various alternative examples, carbon monoxide detection limits of seven hundred fifty (750) parts-per-million, one thousand (1,000) parts-per-million, one thousand one hundred (1,100) parts-per-million, one thousand two hundred (1,200) parts-per-million are variously the threshold between a “safe” and an “unsafe” environmental condition. Alternatively or additionally, a second detection limit may be utilized to determine a second threshold for modifying the operation of the vehicle. In an example, the carbon monoxide second detection limit is one thousand one hundred (1,100) parts-per-million. Further alternatively, the carbon monoxide second detection limit is one of one thousand two hundred fifty (1,250) parts-per-million, one thousand five hundred (1,500) parts-per-million, one thousand seven hundred fifty (1,750) parts-per-million, and two thousand (2,000) parts-per-million.

At 304, the controller 112 determines an environmental condition state based on the sensor data. Determination of the environmental condition state may be comparatively simple or unnecessary where the sensor data is the more generally indicative sensor data as described above; where the sensor data is binary safe/unsafe sensor data the controller 112 may not need to separately determine the environmental condition at all. Alternatively, where the sensor data is “raw” data or more than binary safe/unsafe data, the controller 112 may cross-reference the sensor data against known standards for environmental safety and/or the detection limits described above to determine the environmental condition state. If the environmental condition state is determined to be “safe” then the flow diagram may proceed to operation 310, as discussed below.

The environmental condition state may be determined based on sensor data from multiple sensors 114. For instance, such sensor data may be cumulative, such that while any one sensed environmental condition, such as carbon monoxide or nitrous oxide, may be within safe levels, elevated levels of multiple environmental conditions may be indicative of an environmental condition state that is unsafe or undesirable.

Further, the environmental condition state may be based, at least in part, on a change in environmental condition. Thus, if the sensor data indicates that an environmental condition is increasing though not yet unsafe according to actual concentration, the environmental condition state may still be judged to be unsafe given the rate of change of the environmental condition. The rate of change of the environmental condition may be considered alongside an absolute level of the environmental condition, wherein a rapid change in an amount of, for instance, carbon monoxide may not result in an unsafe condition as long as the absolute concentration of carbon monoxide is below a second threshold lower than an absolute safe/unsafe threshold. In an example, a rate of change of carbon monoxide that would produce an absolute unsafe concentration of carbon monoxide in ten (10) minutes or less and an absolute carbon monoxide concentration of at least eighty (80) percent of a safe/unsafe threshold may be determined to be an unsafe environmental condition state.

The environmental condition state of the vehicle 100 may incorporate multiple degrees. For instance, the environmental condition state may be “safe”, “slightly unsafe”, “moderately unsafe”, or “very unsafe” dependent on the extent to which the sensor data indicates the environmental condition. For instance, an environmental condition that is technically unsafe but which in which a person could operate for some hours without expecting a negative impact may be “slightly unsafe”. An environmental condition that may be immediately harmful or harmful in seconds or minutes of exposure may be “very unsafe”.

Further or alternatively, the environmental condition state may be based, at least in part, on having met the first and/or the second detection threshold, as disclosed above. For instance, the environmental condition state may note that the environmental condition is “unsafe” according to the first detection threshold but not the second detection threshold.

At 306, if the environmental condition state is “unsafe” the controller 112 identifies an operation state of the vehicle 100. The state of the vehicle 100 may be related to the operation of any of a variety of components of the vehicle 100, including the power plant 102, the motive power transmission system 106, the electrical distribution system 108, and the vehicle systems 110. The operation state may relate to whether or not the vehicle 100 is in motion, how fast the vehicle 100 is moving, a gear in which the vehicle 100 is operating, available power, and other operating conditions of the vehicle 100.

The state of the vehicle 100 may relate to the environmental condition that is determined to be unsafe. For instance, while carbon monoxide may theoretically enter the passenger space 200 from any of a variety of sources, carbon monoxide may generally be related to the operation of the power plant 102. Thus, in relation to the identification of an unsafe environmental condition related to carbon monoxide, the controller 112 may determine a state of the vehicle 100 related to the current operating mode of the power plant 102, i.e., whether an engine is running. As will be illustrated later, an unsafe level of carbon monoxide may be addressed by changing the operation of the power plant 102, such as by turning the power plant 102 off and/or of displaying a warning, depending on an the operation state of the vehicle.

In the carbon monoxide example, the state of the vehicle 100 may also be related to whether the vehicle 100 is in motive operation. For instance, the motive operation of the vehicle may be determined based on the state of the motive power transmission system 106. In an example, it may be disadvantageous or undesirable to turn a power plant 102 off if the motive power transmission system 106 is currently delivering power to the wheels and axles 204, i.e., if the vehicle 100 is currently being driven. The state of the vehicle 100, such as whether or not the vehicle 100 is in motive operation, may further be related to the state of the vehicle controls 118, such as whether the vehicle is in drive, park, and so forth, or if the accelerator or brake is currently being applied, and so forth. As noted above, any of a variety of vehicle components 102, 106, 108, 110 not spelled out here with particularity may be considered to determine the state of the vehicle.

In the above example, if the state of motive operation is that the vehicle 100 is in motion, the controller 112 may cross-reference the detected carbon monoxide level against both the first and second detection limits, with the potential change in the operation of the vehicle dependent on which detection threshold has been exceeded. However, if the vehicle 100 is not in motive operation, then the detected carbon monoxide level is compared against the first detection limit but not the second detection limit.

At 308, the operation or state of a vehicle 100 component 102, 106, 108, 110 is controlled based on the determination of an unsafe environmental condition state and the state of the vehicle 100. The control may be a modification of the operation of the vehicle. The modification may be based on the environmental condition that is determined to be unsafe. The modification may be based on the state of the vehicle 100 being in one of a variety of conditions. The control may be to reduce an ongoing presence of the environmental condition, such as by reducing an amount or concentration of the environmental condition as detected by the sensor 114.

For instance, if the level of carbon monoxide is elevated, the power plant 102 is operating, and the motive power transmission system 106 and the vehicle controls 118 show that the vehicle 100 is in “park”, the controller 112 may shut down the power plant 102. Alternatively, the controller 112 may cause the user interface 120 to provide a message, such as an audio and/or visual message, indicating that an unsafe carbon monoxide condition has been detected and that shutting down of the power plant 102 is recommended. Alternatively, the controller 112 may cause the power plant 102 to shut down and provide a message on the user interface 120 indicating that the power plant 102 was shut down because of an unsafe carbon monoxide condition. Alternatively or additionally, the controller 112 may utilize other vehicle systems 110, such as to engage a ventilation system or otherwise operate an environmental control 116 to attempt to reduce the concentration of carbon monoxide in the passenger space 200, open a vehicle 100 window, or otherwise operate vehicle systems 110 to mitigate the unsafe carbon monoxide condition.

By contrast, if the state of the vehicle 100 indicates that the power plant 100 is operating but that the vehicle 100 is in operation, such as because the vehicle is in “drive” and therefore either in motion or likely to be in motion, it may be undesirable to disable the power plant 102. In such an example, the controller 102 may cause the user interface 120 to provide an audio and/or visual message of an unsafe carbon monoxide condition, may cause the environmental controls 116 to engage ventilation systems, may cause a window to open, or the like.

In various examples, the modification of the component 102, 106, 108, 110 may be contingent on the degree to which the environmental condition is unsafe. Thus, a “slightly unsafe” environmental condition may only result in a message provided via the user interface 120 while a “very unsafe” environmental condition may provoke an immediate shutdown of the power plant 102 whether or not the vehicle is in drive. Alternative responses are contemplated with varying degrees of urgency based on the sensed environmental condition.

Further alternatively or additionally, if the vehicle 100 is in motive operation and the first detection limit is met but not the second detection limit, the controller 112 may display a message on the user interface 120 but not shut down the power plant 102. If the vehicle 100 is in motive operation and the second detection limit is met then the controller 112 may shut down the power plant 102. If the vehicle 100 is not in motive operation and the first detection level is met then the controller 112 may shut down the power plant 102.

While the above responses are illustrated with respect to the detection of carbon monoxide, it is to be understood that various system responses are contemplated to alternative environmental conditions. For instance, an environmental condition that is not typically associated with the operation of the power plant, such as a contaminant from outside of the vehicle 100, may result in the environmental controls 116 closing off outside ventilation and recirculating internal air. An environmental condition associated with the electrical distribution system 108, such as particulate matter that might be generated by an electrical fire, may result in shutting down the electrical distribution system 108 but not necessarily shutting down the power plant 102 if the vehicle 100 is in motion.

If the operation or state of a vehicle 100 component 102, 106, 108, 110 as modified permits continued function of the sensor 114, the flow diagram may return to operation 300 and continue to sense the environmental condition. The flowchart may continue through the flow diagram, with the identification of the state of the vehicle 100 at operation 306 being based, at least in part, on the state of the vehicle as modified in operation 308.

At operation 310, if the determination of the environmental condition state at operation 304 indicates that the environmental condition state is “safe”, then it may be determined if the operation state of the vehicle 100 is previously modified. If the vehicle operation has not been previously modified then the flow diagram may return directly to the detection of the environmental condition at operation 300.

At operation 312, if the vehicle operation has been previously modified then the flow diagram may restore the operation of the vehicle 100 based on the now safe condition. Restoration of the state of the vehicle 100 may restore operation of the vehicle 100 and/or components component 102, 106, 108, 110, in whole or in part, based on subsequent sensor data as obtained by the sensor 114, such as may indicate that the environmental condition has returned to safe levels.

It is to be noted that restoration of the operation of the vehicle 100 or components 102, 106, 108, 110 may be contingent on various safety factors. For instance, the controller 112 may register a number of times that the unsafe environmental condition has occurred, such as over a particular time period. Thus, if multiple unsafe carbon monoxide conditions are detected over a period of three (3) hours, the controller 112 may infer that the power plant 102 cannot be operated safely and prevent the future restoration of the operation of the power plant 102 until the power plant 112 has been inspected by a mechanic. Alternatively or additionally, an environmental condition that indicates a potentially catastrophic fault in the vehicle 100 may prevent the restoration of the operation of the vehicle 100 until the vehicle 100 has been inspected.

Additionally, it is to be noted that if the modification of the operation of the vehicle results in the shutting down of the sensor 114 then restoration of vehicle 100 operation may not be possible unless and until the sensor 114 itself is restored, such as through the intervention of a mechanic. In various examples, vehicle 100 operation may be restored, in whole or in part, based on a predetermined time period having elapsed. For instance, operation of the electrical distribution system 108, controller 112, and sensor 114 may be restored automatically after three (3) hours. Such a restoration may be overridden by a manual command, such as to override the time period early, or to prevent restoration of operation at the end of the period of time, such as in the event of a vehicle fire which may make use of the electrical distribution system 108 unsafe.

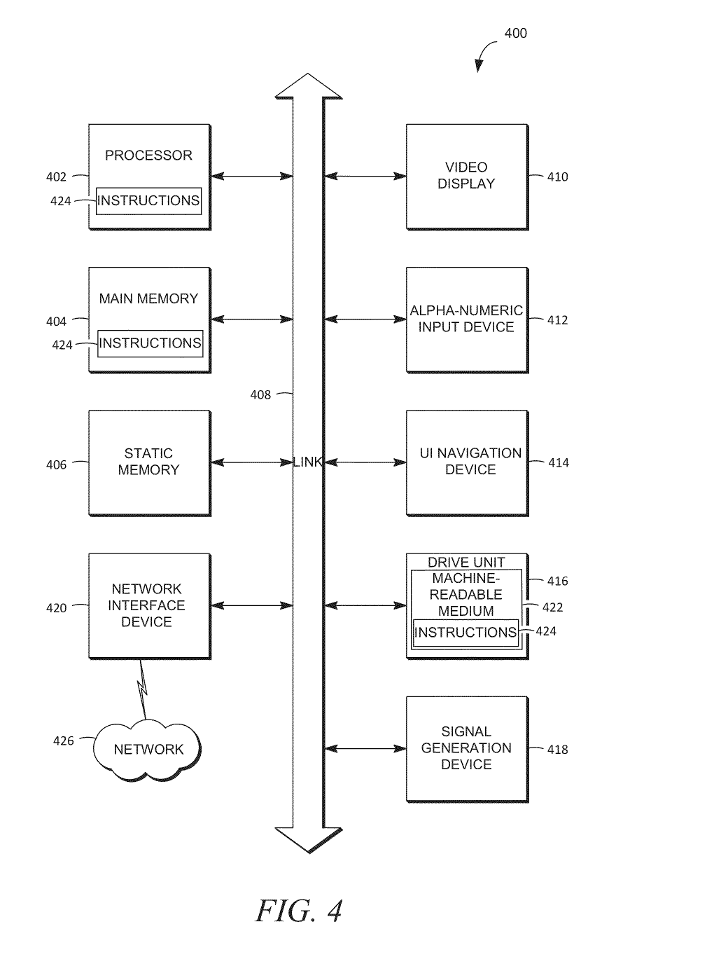

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system and within which instructions 424 (e.g., software) for causing the machine 400 to perform any one or more of the methodologies discussed herein may be executed. In alternative embodiments, the machine 400 operates as a standalone device or may be connected (e.g., networked) to other machines. In a networked deployment, the machine 400 may operate in the capacity of a server machine or a client machine in a server-client network environment, or as a peer machine in a peer-to-peer (or distributed) network environment. The machine 400 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include a collection of machines that individually or jointly execute the instructions 424 to perform any one or more of the methodologies discussed herein.

The machine 400 includes a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. The machine 400 may further include a graphics display 410 (e.g., a plasma display panel (PDP), a light emitting diode (LED) display, a liquid crystal display (LCD), a projector, or a cathode ray tube (CRT)). The machine 400 may also include an alphanumeric input device 412 (e.g., a keyboard), a cursor control device 414 (e.g., a mouse, a touchpad, a trackball, a joystick, a motion sensor, or other pointing instrument), a storage unit 416, a signal generation device 418 (e.g., a speaker), and a network interface device 420.

The storage unit 416 includes a machine-readable medium 422 on which is stored the instructions 424 (e.g., software) embodying any one or more of the methodologies or functions described herein. The instructions 424 may also reside, completely or at least partially, within the main memory 404, within the processor 402 (e.g., within the processor's cache memory), or both, during execution thereof by the machine 400. Accordingly, the main memory 404 and the processor 402 may be considered as machine-readable media. The instructions 424 may be transmitted or received over a network 426 via the network interface device 420.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 422 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 400), such that the instructions, when executed by one or more processors of the machine (e.g., processor 402), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

### Examples

In Example 1, a system optionally includes a sensor configured to detect an environmental condition within a vehicle and a controller, operatively coupled to the sensor, configured to control an operation of the vehicle based, at least in part, on the environmental condition as detected by the sensor and an operation state of the vehicle. The operation state of the vehicle is optionally related, at least in part, to a source of the environmental condition.

In Example 2, the system of Example 1 optionally further includes that the controller is configured to control the operation of the vehicle to reduce an ongoing presence of the environmental condition.

In Example 3, the system of any one or more of Examples 1 and 2 optionally further includes a power plant of the vehicle, wherein the controller is configured to control the operation of the vehicle by disabling operation of the power plant based on the sensor detecting an environmental condition related to the power plant.

In Example 4, the system of any one or more of Examples 1-3 optionally further includes at least one of a motive power transmission system of the vehicle and vehicle controls, and wherein the controller is configured to determine the operation state of the vehicle based on a state of the at least one of the motive power transmission system and the vehicle controls.

In Example 5, the system of any one or more of Examples 1-4 optionally further includes that the controller is configured to disable operation of the power plant if the state of the at least one of the motive power transmission system and the vehicle controls indicates the vehicle is not in motive operation.

In Example 6, the system of any one or more of Examples 1-5 optionally further includes that configured to control the operation of the vehicle based on the environmental condition being an unsafe environmental condition.

In Example 7, the system of any one or more of Examples 1-6 optionally further includes that the environmental condition is an unsafe environmental condition based, at least in part, on a concentration of a contaminant as detected by the sensor.

In Example 8, the system of any one or more of Examples 1-7 optionally further includes that environmental condition is an unsafe environmental condition further based, at least in part, on a change in concentration of the contaminant as detected by the sensor.

In Example 9, the system of any one or more of Examples 1-8 optionally further includes that the contaminant is at least one of a gas and a particulate matter.

In Example 10, the system of any one or more of Examples 1-9 optionally further includes that the contaminant is one of carbon monoxide, a hydrocarbon, a nitrous oxide, and carbon dioxide.

In Example 11, the system of any one or more of Examples 1-10 optionally further includes that the vehicle includes a passenger space and wherein the sensor is configured to detect the environmental condition within the passenger space.

In Example 12, the system of any one or more of Examples 1-11 optionally further includes that, when the operation state of the vehicle is in motive operation, the controller is configured to control the operation of the vehicle by providing a warning relating to the environmental condition upon the environmental condition meeting a first detection limit and by disabling a power plant of the vehicle upon the environmental condition meeting a second detection limit higher than the first detection limit.

In Example 13, the system of any one or more of Examples 1-12 optionally further includes that the environmental contaminant is carbon monoxide, wherein the first detection limit is five hundred (500) parts-per-million and the second detection limit is one thousand one hundred (1100) parts-per-million.

In Example 14, the system of any one or more of Examples 1-13 optionally further includes that, when the operation state of the vehicle is in non-motive operation, the controller is configured to control the operation of the vehicle by disabling a power plant of the vehicle upon the environmental condition meeting a detection limit.

In Example 15, the system of any one or more of Examples 1-14 optionally further includes that the detection limit is five hundred (500) parts-per-million.

In Example 16, a method for controlling the operation of a vehicle optionally includes detecting, with a sensor, an environmental condition within a vehicle and controlling, with a controller, the operation of the vehicle based, at least in part, on the environmental condition as detected by the sensor and an operation state of the vehicle. The operation state of the vehicle is optionally related, at least in part, to a source of the environmental condition.

In Example 17, the method of Example 16 optionally further includes that the operation of the vehicle includes reducing an ongoing presence of the environmental condition.

In Example 18, the method of any one or more of Examples 16 and 17 optionally further includes that controlling the operation of the vehicle includes disabling operation of a power plant of the vehicle based on detecting an environmental condition related to the power plant.

In Example 19, the method of any one or more of Examples 16-18 optionally further includes determining the operation state of the vehicle based on a state of the at least one of a motive power transmission system of the vehicle and vehicle controls of the vehicle.

In Example 20, the method of any one or more of Examples 16-19 optionally further includes that controlling the operation of the vehicle comprises disabling operation of the power plant if the state of the at least one of the motive power transmission system and the vehicle controls indicates the vehicle is not in motive operation.

In Example 21, the method of any one or more of Examples 16-20 optionally further includes that controlling the operation of the vehicle is based on the environmental condition being an unsafe environmental condition.

In Example 22, the method of any one or more of Examples 16-21 optionally further includes that the environmental condition is an unsafe environmental condition based, at least in part, on a concentration of a contaminant as detected by the sensor.

In Example 23, the method of any one or more of Examples 16-22 optionally further includes that the environmental condition is an unsafe environmental condition further based, at least in part, on a change in concentration of the contaminant as detected by the sensor.

In Example 24, the method of any one or more of Examples 16-23 optionally further includes that the contaminant is at least one of a gas and a particulate matter.

In Example 25, the method of any one or more of Examples 16-24 optionally further includes that the contaminant is one of carbon monoxide, a hydrocarbon, a nitrous oxide, and carbon dioxide.

In Example 26, the method of any one or more of Examples 16-25 optionally further includes that the vehicle includes a passenger space and wherein detecting the environmental condition comprises detecting the environmental condition within the passenger space.

In Example 27, the method of any one or more of Examples 16-26 optionally further includes that when the operation state of the vehicle is in motive operation, controlling the operation of the vehicle comprises providing a warning relating to the environmental condition upon the environmental condition meeting a first detection limit and disabling a power plant of the vehicle upon the environmental condition meeting a second detection limit higher than the first detection limit.

In Example 28, the method of any one or more of Examples 16-27 optionally further includes that the environmental contaminant is carbon monoxide, wherein the first detection limit is five hundred (500) parts-per-million and the second detection limit is one thousand one hundred (1100) parts-per-million.

In Example 29, the method of any one or more of Examples 16-28 optionally further includes that the operation state of the vehicle is in non-motive operation, controlling the operation of the vehicle comprises disabling a power plant of the vehicle upon the environmental condition meeting a detection limit.

In Example 30, the method of any one or more of Examples 16-29 optionally further includes that the detection limit is five hundred (500) parts-per-million.

In Example 31, a vehicle optionally comprises an internal combustion engine, a sensor configured to detect an environmental condition created within the vehicle at least in part by the internal combustion engine, and a controller, operatively coupled to the sensor, configured to control an operation of the vehicle based, at least in part, on the environmental condition as detected by the sensor and an operation state of the vehicle. The operation state of the vehicle is optionally related, at least in part, to a source of the environmental condition.

In Example 32, the vehicle of Example 31 optionally further includes that the controller is configured to control the operation of the vehicle to reduce an ongoing presence of the environmental condition.

In Example 33, the vehicle of any one or more of Examples 31 and 32 optionally further includes that the controller is configured to control the operation of the internal combustion engine by disabling operation of the internal combustion engine based on the sensor detecting the environmental condition.

In Example 34, the vehicle of any one or more of Examples 31-33 optionally further includes at least one of a motive power transmission system and vehicle controls, and wherein the controller is configured to determine the operation state of the vehicle based on a state of the at least one of the motive power transmission system and the vehicle controls.

In Example 35, the vehicle of any one or more of Examples 31-34 optionally further includes that the controller is configured to disable operation of the internal combustion engine if the state of the at least one of the motive power transmission system and the vehicle controls indicates the vehicle is not in motive operation.

In Example 36, the vehicle of any one or more of Examples 31-35 optionally further includes that the controller is configured to control the operation of the vehicle based on the environmental condition being an unsafe environmental condition.

In Example 37, the vehicle of any one or more of Examples 31-36 optionally further includes that the environmental condition is an unsafe environmental condition based, at least in part, on a concentration of a contaminant as detected by the sensor.

In Example 38, the vehicle of any one or more of Examples 31-37 optionally further includes that the environmental condition is an unsafe environmental condition further based, at least in part, on a change in concentration of the contaminant as detected by the sensor.

In Example 39, the vehicle of any one or more of Examples 31-38 optionally further includes that the contaminant is at least one of a gas and a particulate matter.

In Example 40, the vehicle of any one or more of Examples 31-39 optionally further includes that the contaminant is one of carbon monoxide, a hydrocarbon, a nitrous oxide, and carbon dioxide.

In Example 41, the vehicle of any one or more of Examples 31-40 optionally further includes a passenger space and wherein the sensor is configured to detect the environmental condition within the passenger space.

In Example 42, the vehicle of any one or more of Examples 31-41 optionally further includes that when the operation state of the vehicle is in motive operation, the controller is configured to control the operation of the vehicle by providing a warning relating to the environmental condition upon the environmental condition meeting a first detection limit and by disabling a power plant of the vehicle upon the environmental condition meeting a second detection limit higher than the first detection limit.

In Example 43, the vehicle of any one or more of Examples 31-42 optionally further includes that the environmental contaminant is carbon monoxide, wherein the first detection limit is five hundred (500) parts-per-million and the second detection limit is one thousand one hundred (1100) parts-per-million.

In Example 44, the vehicle of any one or more of Examples 31-43 optionally further includes that, when the operation state of the vehicle is in non-motive operation, the controller is configured to control the operation of the vehicle by disabling a power plant of the vehicle upon the environmental condition meeting a detection limit.

In Example 45, the vehicle of any one or more of Examples 31-44 optionally further includes that the detection limit is five hundred (500) parts-per-million.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system, comprising:
a sensor configured to detect an environmental condition within a vehicle;
a controller, operatively coupled to the sensor, configured to control an operation of the vehicle based, at least in part, on the environmental condition as detected by the sensor and an operation state of the vehicle;
wherein the operation state of the vehicle is related, at least in part, to a source of the environmental condition.

2. The system of claim 1, wherein the controller is configured to control the operation of the vehicle to reduce an ongoing presence of the environmental condition.

3. The system of claim 2, further comprising a power plant of the vehicle, wherein the controller is configured to control the operation of the vehicle by disabling operation of the power plant based on the sensor detecting an environmental condition related to the power plant.

4. The system of claim 3, further comprising at least one of a motive power transmission system of the vehicle and vehicle controls, and wherein the controller is configured to determine the operation state of the vehicle based on a state of the at least one of the motive power transmission system and the vehicle controls.

5. The system of claim 4, wherein the controller is configured to disable operation of the power plant if the state of the at least one of the motive power transmission system and the vehicle controls indicates the vehicle is not in motive operation.

6. The system of claim 1, wherein the controller is configured to control the operation of the vehicle based on the environmental condition being an unsafe environmental condition.

7. The system of claim 6, wherein the environmental condition is an unsafe environmental condition based, at least in part, on a concentration of a contaminant as detected by the sensor.

8. The system of claim 7, wherein the environmental condition is an unsafe environmental condition further based, at least in part, on a change in concentration of the contaminant as detected by the sensor.

9. The system of claim 7, wherein the contaminant is at least one of a gas and a particulate matter.

10. The system of claim 9, wherein the contaminant is at least one of carbon monoxide, a hydrocarbon, a nitrous oxide, and carbon dioxide.

11. A method for controlling the operation of a vehicle, comprising:
detecting, with a sensor, an environmental condition within a vehicle;
controlling, with a controller, the operation of the vehicle based, at least in part, on the environmental condition as detected by the sensor and an operation state of the vehicle;
wherein the operation state of the vehicle is related, at least in part, to a source of the environmental condition.

12. The method of claim 11, wherein controlling the operation of the vehicle includes reducing an ongoing presence of the environmental condition.

13. The method of claim 12, wherein controlling the operation of the vehicle includes disabling operation of a power plant of the vehicle based on detecting an environmental condition related to the power plant.

14. The method of claim 13, further comprising determining the operation state of the vehicle based on a state of the at least one of a motive power transmission system of the vehicle and vehicle controls of the vehicle.

15. The method of claim 14, wherein controlling the operation of the vehicle comprises disabling operation of the power plant if the state of the at least one of the motive power transmission system and the vehicle controls indicates the vehicle is not in motive operation.

16. The method of claim 11, wherein controlling the operation of the vehicle is based on the environmental condition being an unsafe environmental condition.

17. The method of claim 16, wherein the environmental condition is an unsafe environmental condition based, at least in part, on a concentration of a contaminant as detected by the sensor.

18. The method of claim 18, wherein the environmental condition is an unsafe environmental condition further based, at least in part, on a change in concentration of the contaminant as detected by the sensor.

19. The method of claim 17, wherein the contaminant is at least one of a gas and a particulate matter.

20. The method of claim 19, wherein the contaminant is at least one of carbon monoxide, a hydrocarbon, a nitrous oxide, and carbon dioxide.

21. A vehicle, comprising:
an internal combustion engine;
a sensor configured to detect an environmental condition created within the vehicle at least in part by the internal combustion engine;
a controller, operatively coupled to the sensor, configured to control an operation of the vehicle based, at least in part, on the environmental condition as detected by the sensor and an operation state of the vehicle;
wherein the operation state of the vehicle is related, at least in part, to a source of the environmental condition.

22. The vehicle of claim 21, wherein the controller is configured to control the operation of the vehicle to reduce an ongoing presence of the environmental condition.

23. The vehicle of claim 2, wherein the controller is configured to control the operation of the internal combustion engine by disabling operation of the internal combustion engine based on the sensor detecting the environmental condition.

24. The vehicle of claim 23, further comprising at least one of a motive power transmission system and vehicle controls, and wherein the controller is configured to determine the operation state of the vehicle based on a state of the at least one of the motive power transmission system and the vehicle controls.

25. The vehicle of claim 24, wherein the controller is configured to disable operation of the internal combustion engine if the state of the at least one of the motive power transmission system and the vehicle controls indicates the vehicle is not in motive operation.
